(19) United States
(12) Patent Application Publication
(10) Pub. No.: US 2003/0225838 A1
(43) Pub. Date: Dec. 4, 2003

(54) Method and apparatus for implementing extended breakpoint notification

(75) Inventors: Cary Lee Bates, Rochester, MN (US); Steven Gene Halverson, Rochester, MN (US)

Correspondence Address: IBM CORPORATION, ROCHESTER IP LAW DEPT. 917, 3605 HIGHWAY 52 NORTH, ROCHESTER, MN, 55901-7829, US

(73) Assignee: International Business Machines Corporation, Armonk, NY

(21) Appl. No.: 10/161,252

(22) Filed: May 31, 2002

(51) Int. Cl. G06F 15/16; G06F 9/44

(52) U.S. Cl. 709/206; 717/125; 717/129

(57) ABSTRACT

A method, apparatus and computer program product are provided for implementing extended breakpoint notification. A breakpoint properties list is stored. The breakpoint properties list includes user selected entries associated with each breakpoint. The user selected entries include at least one of an e-mail address or a pager number. A program is executed and a breakpoint occurring in the program is identified. Then the user is notified of the identified breakpoint utilizing at least one of the e-mail address or the pager number associated with the identified breakpoint. Different e-mail addresses and pager numbers can be specified with each breakpoint, allowing different users to be notified. Working hours can be specified, so that an e-mail or page is only sent outside of the working hours. The e-mail and page notification feature also is associated with selected debugger functions, such as, memory watches or address compare breakpoints.

### FIELD OF THE INVENTION

The present invention relates generally to the data processing field, and more particularly, relates to a method, apparatus and computer program product for implementing extended breakpoint notification.

### DESCRIPTION OF THE RELATED ART

Many times programmers have to debug problems that are hard to reproduce. Often times programmers will have to set up scripts which run the multiple copies of the program over and over while waiting for the problem to occur.

The problem is that the programmer often does not know when the problem will be produced, so they are stuck in the machine room monitoring the test waiting for the problem to occur at which time their breakpoint will be hit, and the problem can finally be debugged.

### SUMMARY OF THE INVENTION

A principal object of the present invention is to provide a method, apparatus and computer program product for implementing extended breakpoint notification. Other important objects of the present invention are to provide such method, apparatus and computer program product for implementing extended breakpoint notification substantially without negative effect and that overcome many of the disadvantages of prior art arrangements.

In brief, a method, apparatus and computer program product are provided for implementing extended breakpoint notification. A breakpoint properties list is stored. The breakpoint properties list includes user selected entries associated with each breakpoint. The user selected entries include at least one of an e-mail address or a pager number. A program is executed and a breakpoint occurring in the program is identified. Then the user is notified of the identified breakpoint utilizing at least one of the e-mail address or the pager number associated with the identified breakpoint.

In accordance with features of the invention, different e-mail addresses and pager numbers can be specified with each breakpoint, allowing different users to be notified. Working hours can be specified, so that an e-mail or page is only sent outside of the working hours. The e-mail and page notification feature also is associated with selected debugger functions, such as, memory watches or address compare breakpoints.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B are block diagram representations illustrating a computer system and operating system for implementing extended breakpoint notification in accordance with the preferred embodiment;

FIG. 2 is a flow chart illustrating exemplary steps for implementing extended breakpoint notification in accordance with the preferred embodiment;

FIG. 3 is a diagram illustrating an exemplary menu user entry screen for receiving user selected data for implementing extended breakpoint notification in accordance with the preferred embodiment; and

FIG. 4 is a block diagram illustrating a computer program product in accordance with the preferred embodiment.

### DETAILED DESCRIPTION OF THE PREFERRED EMBODIMENTS

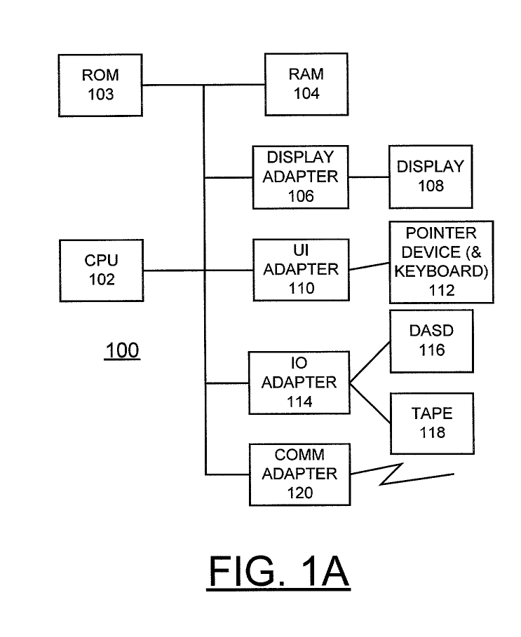

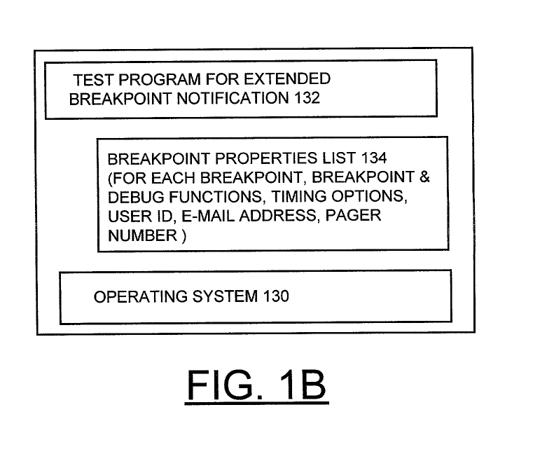

Having reference now to the drawings, in FIGS. 1A and 1B, there is shown a computer or data processing system generally designated by the reference character 100 for carrying out the extended breakpoint notification methods of the preferred embodiment. As shown in FIG. 1A, computer system 100 includes a central processor unit (CPU) 102, a read only memory 103, a random access memory 104, a display adapter 106 coupled to a display 108. CPU 102 is connected to a user interface (UI) adapter 110 connected to a pointer device and keyboard 112. CPU 102 is connected to an input/output (10) adapter 114 connected to a direct access storage device (DASD) 116 and a tape unit 118. CPU 102 is connected to a communications adapter 120 providing a communications function. It should be understood that the present invention is not limited to a computer model with a single CPU, or other single component architectures as shown in FIG. 1A.

As shown in FIG. 1B, computer system 100 includes an operating system 130, a test program for extended breakpoint notification 132 of the preferred embodiment. A breakpoint properties list 134 is stored and maintained in accordance with the preferred embodiment.

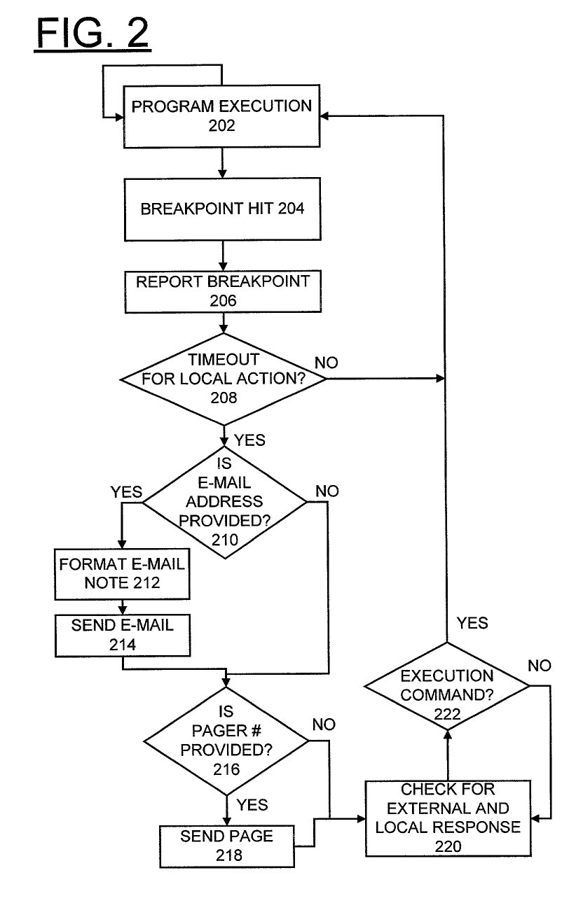

Various commercially available computers can be used for computer system 100; for example, an IBM personal computer. CPU 102 is suitably programmed by the test program for extended breakpoint notification 132 to execute the flowchart of FIG. 2 and to store and maintain the breakpoint properties list 134.

In accordance with features of the preferred embodiment, a user provides an e-mail address and/or a pager number to be associated with a particular breakpoint so that when the breakpoint occurs the user will be notified. An e-mail message and/or page are automatically sent when the breakpoint occurs. As shown if FIG. 1B, the stored breakpoint properties list 134 includes for each breakpoint including breakpoint and debug functions, timing options and one or more user IDs. The stored breakpoint properties list 134 includes, one or more e-mail addresses, and optionally includes pager numbers for each breakpoint.

In accordance with features of the preferred embodiment, one or more e-mail addresses and/or pager numbers are specified with each breakpoint and a different e-mail address can be specified with each breakpoint to allow for different developers to be notified depending on which breakpoint is hit. Timing options are provided. For instance, if the breakpoint is hit and someone immediately starts to interact with debugger functions of test program 132 then the e-mail or page may not be sent, but if the debugger sits unattended for a set period of time, then the e-mail message and/or page is sent. Working hours can be specified so the paging or e-mail will only be sent outside of these hours. This paging/e-mail feature also is associated with selected debugger functions, such as memory watches that are known as address compare breakpoints.

In accordance with features of the preferred embodiment, an e-mail message includes, for example, the time of the breakpoint hit or the selected debugger function occurring; the user ID being used to debug the problem; the program module and the number of the breakpoint or the selected debugger function; the values of the local variable, monitored variables, registers and memory at the time of the breakpoint hit or the selected debugger function occurring.

It should be understood that various other information could be include in the e-mail message. For example, the program source with the breakpoint location flagged can be included in the message. The e-mail message information should allow the programmers to think about the problem, and allow the programmers to determine whether they need to come back to work or not.

Referring now to FIG. 2, there are shown exemplary steps for implementing extended breakpoint notification in accordance with the preferred embodiment. Program execution is performed as indicated in a block 202. A breakpoint occurs as indicated in a block 204. Then the breakpoint is reported to a local graphical user interface (GUI) as indicated in a block 206. Checking for a set time period for local action is performed as indicated in a decision block 208.

When a timeout for local action occurs, then checking the breakpoint properties 134 for an e-mail address is performed as indicated in a decision block 210. When an e-mail address is identified, an e-mail note is formatted as indicated in a block 212. When the e-mail note is being formatted at block 212, specified working hours are checked so the paging or e-mail will only be sent outside of these hours. The e-mail note is sent as indicated in a block 214. Then checking the breakpoint properties 134 for a pager number is performed as indicated in a decision block 216. When a pager number is identified, a page is sent as indicated in a block 218.

Checking for an external or local response is performed as indicated in a block 220. A mail agent can be employed at block 220 to process incoming mail which would allow the user to mail back one of a subset of debug commands that would allow execution to resume. Various options also are enabled to ensure security, such as, the incoming command message must come from the same user or the same user ID number that received the breakpoint notification e-mail sent at block 214. Checking for an execution command is performed as indicated in a decision block 222. When an execution command is received, then program execution resumes at block 202. A conformation message would also be sent when the message containing a debug command is processed.

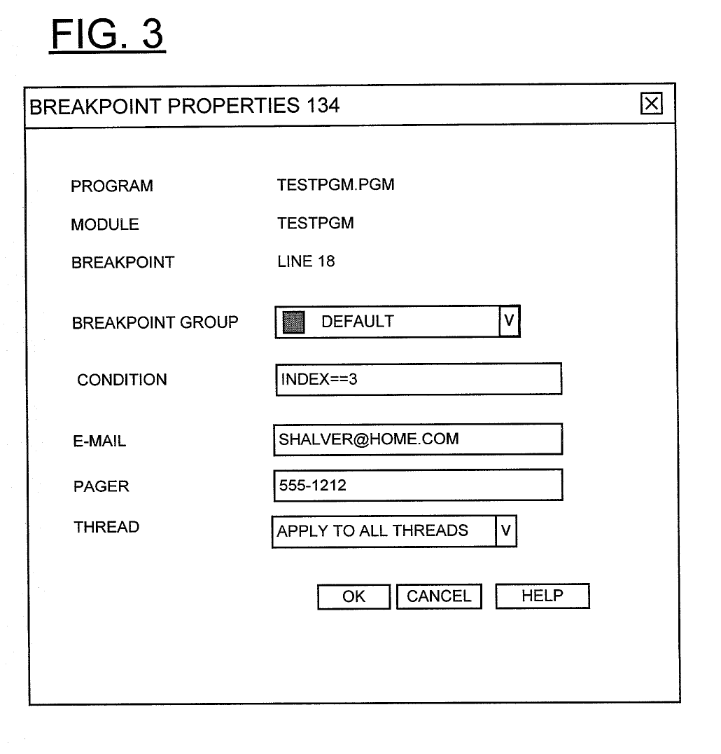

FIG. 3 illustrates an exemplary menu user entry screen for receiving user selected data for breakpoint properties 134 for implementing extended breakpoint notification in accordance with the preferred embodiment. The breakpoint properties 134 include a program, module, and breakpoint information. The breakpoint properties 134 include user selected entries of breakpoint group, condition, e-mail, pager number, and thread options. The user selected condition entry is used to set a conditional breakpoint, for example, as shown only when index equals 3. The user selected thread entry is used to specify a selected thread, a current thread, or apply to all threads. A different user e-mail address and pager number can be used with each of multiple various selected entries. As shown in FIG. 3, the user is in the process of setting a breakpoint and has specified that when the breakpoint is hit that an e-mail message should be sent to a designated home e-mail address and a page sent to a designated pager number.

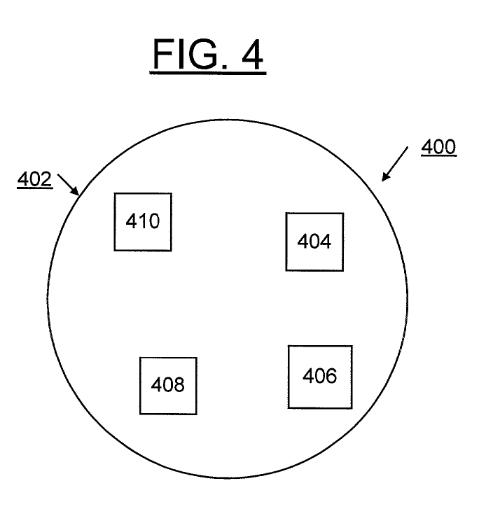

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the methods for implementing extended breakpoint notification of the preferred embodiment in the system 100 of FIGS. 1A and 1B.

A sequence of program instructions or a logical assembly of one or more interrelated modules defined by the recorded program means 404, 406, 408, 410, direct the computer system 100 for implementing extended breakpoint notification of the preferred embodiment.

While the present invention has been described with reference to the details of the embodiments of the invention shown in the drawing, these details are not intended to limit the scope of the invention as claimed in the appended claims.

What is claimed is:

1. A method for implementing extended breakpoint notification comprising the steps of:
storing a breakpoint properties list; said breakpoint properties list including user selected entries associated with each breakpoint; said user selected entries including at least one of an e-mail address or a pager number;
executing a program;
identifying a breakpoint occurring in said program; and
notifying the user of said identified breakpoint utilizing said at least one of said e-mail address or said pager number associated with said identified breakpoint.

2. A method for implementing extended breakpoint notification as recited in claim 1 wherein the step of notifying the user of said identified breakpoint utilizing said at least one of said e-mail address or said pager number includes the step of identifying a set time period for receiving a local response before sending an e-mail or page to notify the user of said identified breakpoint.

3. A method for implementing extended breakpoint notification as recited in claim 1 wherein the step of storing said breakpoint properties list includes the step of storing said user selected entries including at least one of an e-mail address or a pager number associated with selected debugger functions, said selected debugger functions including address compare breakpoints.

4. A method for implementing extended breakpoint notification as recited in claim 1 includes the steps responsive to notifying the user of said identified breakpoint, of checking for both a local response and an external response, identifying an execution command, and resuming program execution.

5. A method for implementing extended breakpoint notification as recited in claim 1 wherein the step of notifying the user of said identified breakpoint utilizing said at least one of said e-mail address or said pager number associated with said identified breakpoint includes the steps of formatting and sending an e-mail message; said e-mail message including at least one of a time of said identified breakpoint occuring; a program module and a number for said identified breakpoint; a user ID, and a value of a local variable, monitored variables, registers and memory at said time of said identified breakpoint occuring.

6. A computer program product for implementing extended breakpoint notification in a computer system including a central processor unit, said computer program product including a plurality of computer executable instructions stored on a computer readable medium, wherein said instructions, when executed by said central processor unit, cause the central processor unit to perform the steps of:
storing a breakpoint properties list; said breakpoint properties list including user selected entries associated with each breakpoint and each selected debugger function; said user selected entries including at least one of an e-mail address or a pager number;
executing a program;
identifying a breakpoint or a selected debugger function occurring in said program; and
notifying the user of said identified breakpoint or said identified selected debugger function utilizing said at least one of said e-mail address or said pager number associated with said identified breakpoint or said identified selected debugger function.

7. A computer program product for implementing extended breakpoint notification as recited in claim 6 wherein the step of notifying the user of said identified breakpoint utilizing said at least one of said e-mail address or said pager number includes the step of identifying a set time period for receiving a local response before sending an e-mail or page to notify the user of said identified breakpoint.

8. A computer program product for implementing extended breakpoint notification as recited in claim 6 includes the steps, responsive to notifying the user, of checking for both a local response and an external response, identifying an execution command, and resuming program execution.

9. A computer program product for implementing extended breakpoint notification as recited in claim 6 wherein the step of storing said breakpoint properties list includes the step of storing user selected timing options.

10. Apparatus for implementing extended breakpoint notification comprising:
a memory for storing a breakpoint properties list; said breakpoint properties list including user selected entries associated with each breakpoint; said user selected entries including at least one of an e-mail address or a pager number;
a processor coupled to said memory; said processor executing a program and utilizing said breakpoint properties list for performing the steps of:
identifying a breakpoint occurring in said program; and
notifying the user of said identified breakpoint utilizing said at least one of said e-mail address or said pager number associated with said identified breakpoint.

11. Apparatus for implementing extended breakpoint notification as recited in claim 10 wherein said breakpoint properties list further includes user selected entries associated with each selected debugger function; and wherein said processor utilizing said breakpoint properties list for further performing the steps of identifying a selected debugger function occurring in said program; and notifying the user of said identified selected debugger function utilizing said at least one of said e-mail address or said pager number associated with said identified selected debugger function.

12. Apparatus for implementing extended breakpoint notification as recited in claim 10 wherein the step of notifying the user of said identified breakpoint includes the step of identifying a set time period for receiving a local response.

13. Apparatus for implementing extended breakpoint notification as recited in claim 10 wherein the step of storing said breakpoint properties list includes the step of storing user selected timing options.

14. Apparatus for implementing extended breakpoint notification as recited in claim 10 wherein said processor utilizing said breakpoint properties list for further performing the steps, responsive to notifying the user of said identified breakpoint, of checking for both a local response and an external response, identifying an execution command, and resuming program execution.
